(19) United States
(12) Patent Application Publication
(10) Pub. No.: US 2008/0240524 A1
(43) Pub. Date: Oct. 2, 2008

(54) ORGAN BASED HANGING PROTOCOL FOR A DIAGNOSTIC READING WORKSTATION

(75) Inventors: Murali Kumaran Kariathungal, Hoffman Estates, IL (US); Prakash Mahesh, Hoffman Estates, IL (US); Mark Morita, Arlington Heights, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/694,380

(22) Filed: Mar. 30, 2007

(51) Int. Cl. G06K 9/00; G06F 15/16

(52) U.S. Cl. 382/128; 709/203

(57) ABSTRACT

Certain embodiments of the present invention provide a method for displaying a volume image set. The method includes selecting an image hanging protocol and displaying one or more volume images based at least in part on the image hanging protocol. The image hanging protocol includes a rule set for displaying the one or more volume images based at least in part on a body part component. Certain embodiments of the present invention provide a system for displaying a volume image set. The system includes a display device adapted to display one or more volume images based at least in part on an image hanging protocol. The image hanging protocol includes a rule set for displaying the one or more volume images based at least in part on a body part component.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to an improvement in the selection and presentation of medical imaging studies. More specifically, the present invention relates to image hanging protocols that specify body part components, such as organs.

Picture archiving and communication systems (“PACS”) connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

A series or sequence of a plurality of medical images is an imaging study. In general, an imaging study that is the most recent imaging study of a patient or is the imaging study currently being examined by a radiologist will be referred to as a current imaging study.

In order to properly diagnose a current imaging study, a radiologist must examine one or more previously acquired images of the same patient and compare these images to images of a current study. An imaging study that includes two or more previously acquired images is a historical imaging study. Furthermore, a historical imaging study whose images are relevant for comparing with the images of a current imaging study is a comparison imaging study. For example, images that are associated with or display the same anatomy are relevant for comparison purposes.

The images of an imaging study are displayed in a particular spatial layout and/or temporal sequence. In other words, the images may be displayed in certain positions on a display device relative to each other (a spatial layout, for example). The images may also be displayed in a certain ordered sequence by displaying image A first, followed by image B, followed by image C, and so on (a temporal sequence, for example). The spatial and/or temporal presentation of images is directed by a set of display rules. A display rule may include a set of instructions stored on a computer-readable media that direct the presentation of images on a display workstation. A set of display rules is known as an image hanging protocol. In general, an image hanging protocol is a series of display rules that dictate the spatial and/or temporal layout and presentation of a plurality of images.

Image hanging protocols are used in current PACS systems to present images of a diagnostic study for display. Image hanging protocols allow a user to specify studies for population into image layouts or regions, as well as the appearance of the layouts or regions. Furthermore, the user may specify which image hanging protocols are used to display which studies. The idea is to automate the presentation of images in the way most desired by the user.

Medical diagnostic imaging devices can generate data about a body part in two physical or spatial dimensions using pixels (for example, x, y, and/or time). More advanced medical diagnostic imaging devices may be able to generate vast amounts of data about a body part in three physical or spatial dimensions using voxels (for example, x, y, z, and/or time). A typical 3-dimensional image is a volume image constructed by stacking a group of 2-dimensional slice images acquired by a Computed Tomography (CT) or Magnetic Resonance Imaging (MRI) scanner on top of one another.

Current image hanging protocols use body parts, such as head and chest, and image parameters to hang images on a radiology workstation. Use of current image hanging protocols may lead to display of incorrect images. Moreover, current image hanging protocols, such as those disclosed in US Patent Publication Numbers 20060146071 and 20040202387, do not consider body part components, such as organs, organ systems, or other functional systems. Additionally, visualization software, such as GE Healthcare's Advantage Workstation (http://www.gehealthcare.com/euen/advantage-workstation/index.html) and TeraRecon's AquariusNET (www.terarecon.com/products/medical.html) do not include body part component based image hanging protocols.

Thus, there is a need for an efficient way for a user to view organs or functional systems of a body part of interest upon the display of a study. This is especially true for examination of discrete organs or functional systems. For example, a radiologist performing a colon analysis needs to be able to view the colon as efficiently as possible, which may include separating the volume image of the colon from the entire volume image. Even for a radiologist or other user, elimination of time lost due to extra steps in a workflow can greatly contribute to the efficiency and the quality of healthcare.

### BRIEF SUMMARY OF THE INVENTION

Certain embodiments of the present invention provide a method for displaying a volume image set. The method includes selecting an image hanging protocol and displaying one or more volume images based at least in part on the image hanging protocol. The image hanging protocol includes a rule set for displaying the one or more volume images based at least in part on a body part component.

Certain embodiments of the present invention provide a system for displaying a volume image set. The system includes a display device adapted to display one or more volume images based at least in part on an image hanging protocol. The image hanging protocol includes a rule set for displaying the one or more volume images based at least in part on a body part component.

Certain embodiments of the present invention provide a computer-readable storage medium. The computer-readable storage medium includes a set of instructions for execution on a computer. The set of instructions includes a selection routine configured to select an image hanging protocol and a display routine configured to display a volume image set based at least in part on the image hanging protocol. The image hanging protocol includes a rule set for displaying the volume image set based at least in part on a body part component.

Certain embodiments of the present invention provide an image hanging protocol. The image hanging protocol includes a rule set for displaying a volume image set based at least in part on a body part component.

### BRIEF DESCRIPTION OF SEVERAL VIEWS OF THE DRAWINGS

FIG. 1 illustrates an exemplary PACS system according to an embodiment of the present invention.

FIG. 2 illustrates an exemplary image display method according to an embodiment of the present invention.

FIG. 3 illustrates an exemplary image display according to an embodiment of the present invention.

FIG. 4 illustrates an exemplary image display method according to an embodiment of the present invention.

FIG. 5 illustrates an exemplary PACS system according to an embodiment of the present invention.

FIG. 6 illustrates an exemplary image processing method according to an embodiment of the present invention.

FIG. 7 illustrates an exemplary clinical review workflow according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

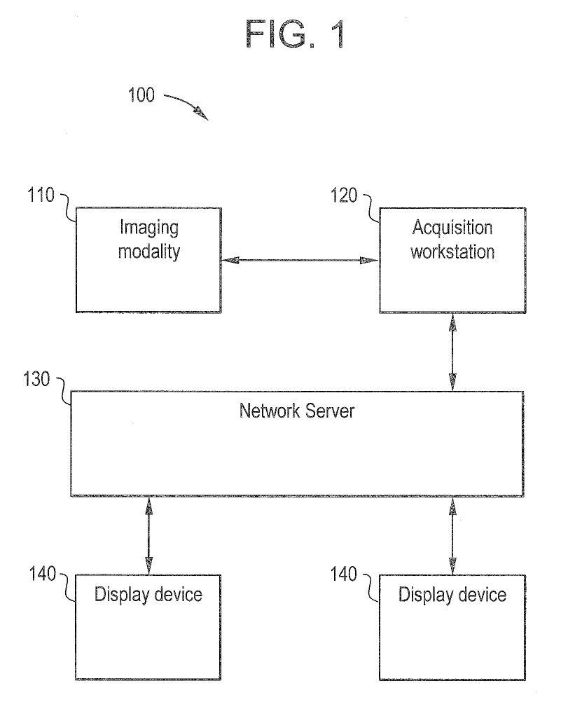

FIG. 1 illustrates an exemplary PACS system 100 according to an embodiment of the present invention. PACS system 100 includes an imaging modality 110, an acquisition workstation 120, a network server 130, and two display devices 140. While system 100 is illustrated in FIG. 1 as including a single imaging modality 110, a single acquisition workstation 120, a single network server 130, and two display devices 140, system 100 can include any number of imaging modalities 110, acquisition workstations 120, network servers 130, and/or display devices 140. In other words, no embodiment of the present invention is in any way limited to the illustration of system 100 as illustrated in FIG. 1.

Imaging modality 110 is capable of communicating with acquisition workstation 120. Acquisition workstation 120 is capable of communicating with imaging modality 110 and server 130. Server 130 is capable of communicating with acquisition workstation 120 and display devices 140. Display devices 140 are capable of communicating with server 130. In another embodiment of the present invention, display devices 140 may also communicate directly with acquisition workstation 120.

In operation, imaging modality 110 obtains one or more images of a patient anatomy. Imaging modality 110 can include any device capable of capturing an image of a patient anatomy, such as a medical diagnostic imaging device. For example, imaging modality 110 can include an x-ray imager, ultrasound scanner, magnetic resonance imager, computed radiography/tomography imager, nuclear imager, or the like. Image data representative of the image(s) is communicated between imaging modality 110 and acquisition workstation 120. The image data can be communicated electronically over a wired or wireless connection, for example.

Acquisition workstation 120 may apply one or more preprocessing functions to the image data. The preprocessing functions may be employed to prepare the image(s) for viewing on one or more display devices 140 and/or to prepare the image(s) for storage at one or more of display devices 140 and server 130. For example, acquisition workstation 120 may convert raw image data into a DICOM standard format or attach a DICOM header. In another example, a preprocessing function may include contrast or frequency preprocessing of an image.

Acquisition workstation 120 may apply a 3-dimensional processing function. For example, acquisition workstation 120 may reconstruct a volume image by stacking 2-dimensional slice images on top of each other. Acquisition workstation 120 may, for example, construct volume elements, or voxels, from RGB and alpha (opacity) values. The method of reconstruction may be directed by a user of system 100. Alternatively, reconstruction may occur automatically.

Acquisition workstation 120 may attach or associate image data attributes with the image(s). An image data attribute can include any electronically communicable data representative of information relevant to the image(s), patient, patient anatomy, and/or medical or imaging procedure, for example. Exemplary image data attributes include data representative of an imaging procedure, one or more DICOM tag(s) and/or one or more patient anatomies or mapped anatomies.

An image data attribute representative of an imaging procedure can include data representative of the procedures used to obtain the image(s) (to which the image data attribute is attached or associated). An imaging procedure can include a sequence of imaging steps used to obtain one or more images. For example, an imaging procedure can include the insertion of a contrast agent in a patient and then taking one or more images of the patient anatomy that includes the contrast agent. In another example, an imaging procedure may include the acquisition of one or more images without using any sort of contrast agent.

An imaging procedure may include the taking of one or more images of a certain patient anatomy. For example, an imaging procedure may identify which patient anatomy (such as a patient's head, neck or chest) is featured or shown in one or more images, for example.

An imaging procedure may also include the particular imaging modality used to obtain one or more images and/or particular type or class of imaging modality used to obtain one or more images. A particular imaging modality may be a certain or particular imaging modality device of a plurality of imaging modality devices. In another example, a particular type or class of imaging modality may be a C-arm x-ray imaging device, magnetic resonance (“MR”) imaging device, etc.

An imaging procedure may also include a representation of a user that employed an imaging modality to obtain the image(s). For example, an imaging procedure may include a representation of an identity of a radiologist who used an MR imaging device to obtain the image(s).

An image data attribute may include data representative of one or more DICOM tags. A DICOM tag may be attached to or associated with image data by imaging modality 110 and/or acquisition workstation 120. A DICOM tag may include any data specified by the DICOM Standard or any custom data allowed for by the DICOM Standard. For example, a DICOM tag may include image display data (e.g., (7FE0,0010) Pixel Data), image data characteristics (e.g., (0028,0002) Samples Per Pixel, (0028,0004) Photometric Interpretation), image capture characteristics (e.g., (0018,1050) Spatial Resolution, (0018,5101) View Position), anatomy data (e.g., (0018,0015) Body Part Examined), imaging device data (e.g., (0008,0060) Modality, (0008,1090) Manufacturer's Model Name), study-specific data (e.g., (0008,0020) Study Date, (0008,0030) Study Time), patient-specific data (e.g., (0010,0010) Patient's Name, (0010,0030) Patient's Birth Date), or any other data allowed for by the DICOM Standard.

An image data attribute may include data representative of a patient anatomy. Such data may include one or more mapped body parts. A mapped body part is any body part or anatomy featured in the image(s). An image data attribute that includes a mapped body part may be input by a user of system 100. For example, a radiologist may list or statically map the body part(s) or anatomy(ies) to be examined in an imaging procedure and/or featured in one or more images. Such a list may be attached to or associated with the image(s) as an image data attribute.

An image data attribute may also include data representative of a body part component. A body part component is any organ, organ system, or other functional system, or portion thereof, featured in the image(s). An image data attribute that includes a functional system may be input by a user of system 100. Alternatively, an image data attribute that includes a functional system may be input automatically.

An image data attribute may also include a label that associates or links a voxel with an organ and/or functional system. For example, each voxel in a volume image may be associated with one or more organs and/or functional systems. A user of system 100 may link a particular voxel to an organ and/or functional system. Any number of methods may be employed to link a voxel to an organ and/or functional system. For example, a look-up table may be employed to associate a voxel with an organ and/or functional system. Alternatively, or in conjunction, image processing tools, such as segmentation, classification, and pattern recognition, may be employed.

The image data (and associated image data attribute(s)) may then be communicated between acquisition workstation 120 and server 130. The image data may be communicated electronically over a wired or wireless connection.

In another embodiment of the present invention, as described above, image data (and associated image data attribute(s)) may be directly communicated between acquisition workstation 120 and one or more display devices 140. The image data and image data attribute(s) may be communicated over a wired or wireless connection.

Server 130 can include any computer-readable storage and retrieval device that is accessible over an intranet or over the Internet. Server 130 can include a computer-readable storage medium suitable for storing the image data for later retrieval and viewing at a display device 140. Server 130 can also include a computer-readable storage medium suitable for storing one or more image hanging protocols and/or volume images, as described in more detail below.

Images (and associated image data attributes) and/or one or more image hanging protocols may be communicated between server 130 and one or more display devices 140. The image data and associated image data attribute(s) and/or comparison rules may be communicated over a wired or wireless connection or transferred on a physical media, such as magnetic tape.

One or more display devices 140 are capable of communication with or configured to communicate with server 130. A display device 140 can include any device capable of displaying volume images of an imaging study. An imaging study is a group of one or more images. An imaging study may be used in a PACS system to make a diagnosis based on one or more images. For example, as described above, a radiologist using system 100 may employ a display device 140 to analyze a series of volume images of a patient's lungs. The radiologist may use the volume images to determine whether the patient's lungs include a tumor.

As described above, display devices 140 can include any device capable of presenting an imaging study. For example, one exemplary display device 140 includes a display workstation in a PACS system. A display workstation 140 can include a general purpose processing circuit, a network server 130 interface, a software memory, an input device (such as a keyboard, mouse, stylus, microphone, etc.) and an output device (such as an image display monitor or computer monitor), for example. The network server 130 interface may be implemented as a network card connecting to a TCP/IP based network, but may also be implemented as a parallel port, USB, or FireWire interface, for example. While one exemplary display device 140 is described, this example should not be construed as limiting the present invention to just one display device 140. As described above, a display device 140 includes any device capable of presenting or displaying an imaging study to a user. Therefore, a display device 140 may also be embodied in a wireless display device, for example.

As described above, display devices 140 may retrieve or receive image data (for example, an imaging study) from server 130 for display to one or more users. For example, a display device 140 may retrieve or receive an imaging study that includes a computed radiography (“CR”) image of a patient's chest. A radiologist may then examine the image as displayed on a display device for any objects of interest such as, tumors or lesions.

Display devices 140 may also be capable of retrieving/receiving or configured to retrieve/receive one or more hanging protocols from server 130. For example, a default hanging protocol may be communicated to display workstation 140 from server 130.

Display devices 140 may present one or more imaging studies according to a hanging protocol. As described above, a hanging protocol is a set of display rules for presenting, formatting, and otherwise organizing images on a display device of a display device 140. A display rule is a convention for presenting one or more images in particular temporal and/or spatial layout or sequence. For example, a hanging protocol may include a set of computer-readable instructions (or display rules, for example) that direct a computer to display a plurality of images in certain locations on a display device and/or display the plurality of images in a certain sequence or order. In another example, a hanging protocol may include a set of computer-readable instructions that direct a computer to place a plurality of images in multiple screens and/or viewing areas on a display device 140. In general, a hanging protocol may be employed to present a plurality of images for a diagnostic examination of a patient anatomy featured in the images.

A hanging protocol may direct, for example, a display device 140 to display an anterior-posterior (“AP”) image adjacent to a lateral image of the same patient anatomy. In another example, a hanging protocol may direct display device 140 to display the AP image before displaying the lateral image (in other words, prior in time). In general, a hanging protocol dictates the spatial and/or temporal presentation of a plurality of images in one or more imaging studies at a display device 140. A hanging protocol may also be used to select images and/or imaging studies to present at display device 140.

A hanging protocol may also direct, for example, a display device 140 to display body part components, including an organ and/or functional system. For example, a hanging protocol may dictate the spatial and/or temporal presentation of a plurality of volume images in one or more imaging studies at a display device 140. A hanging protocol may direct a display device 140 to display functional systems side by side, for example. A hanging protocol may also direct a display device 140 to display an organ or functional system in isolation. For example, a hanging protocol may employ filters that specify the organ or functional component to be displayed on a display device 140. The filter may remove or eliminate voxels that are not associated with the organ or functional system of interest. Any number of methods may be employed to eliminate or remove voxels that are not associated with the organ or functional system of interest. For example, a look-up table may be employed to eliminate or remove voxels that are not associated with the organ or functional system of interest. Alternatively, or in conjunction, image processing tools, such as segmentation, classification, and pattern recognition, may be employed.

As discussed above, the components, elements, and/or functionality of the PACS system 100 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

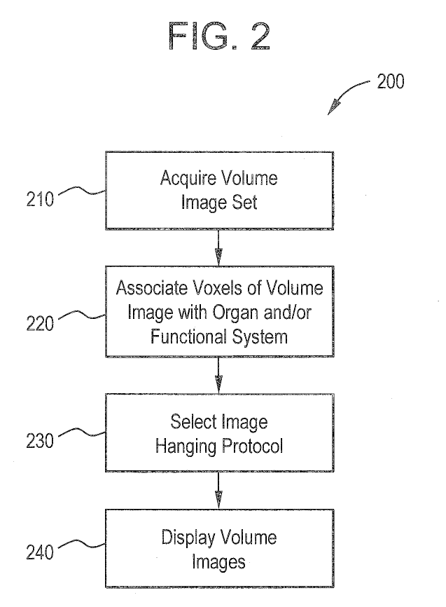

FIG. 2 illustrates an image display method 200 according to an embodiment of the present invention. The method 200 includes the following steps, which are described below in more detail. At step 210, a volume image set is acquired. At step 220, each voxel of a volume image is associated with an organ or functional system. At step 230, an image hanging protocol is selected. At step 240, one or more images are displayed based at least in part on the selected imaging hanging protocol. The method 200 is described with reference to the elements of the PACS system 100 described above, but it should be understood that other implementations are possible.

At step 210, a volume image set is acquired. The volume image set may be acquired by the PACS system 100. More particularly, the volume image set may be acquired by the imaging modality 110 of the PACS system 100. The volume image set may include one or more volume images. PACS system 100 may have applied one or more preprocessing functions to the image data. For example, PACS system 100 may have applied a 3-dimensional processing function or attached or associated image data attributes with the volume image(s).

At step 220, each voxel of a volume image is associated with an organ and/or functional system. A user of system 100 may manually link a particular voxel to an organ and/or functional system. Alternatively, a voxel may be automatically associated with an organ and/or functional system. For example, a lookup up table can be used to associate a voxel with an organ and/or functional system. Alternatively, or in conjunction, image processing tools, such as segmentation, classification, and pattern recognition, may be employed to associate a voxel with an organ and/or functional system.

At step 230, an image hanging protocol is selected. The image hanging protocol may include a rule set. The rule set may include one or more rules. For example, the rule set may include a rule for displaying an organ and/or functional system. As another example, the rule set may include a rule for eliminating or removing voxels that are not associated with the organ or functional system of interest. As another example, the rule set may include a rule for displaying an organ and/or functional system in isolation.

In certain embodiments of the present invention, the image hanging protocol may be created and/or selected by a user, such as a healthcare provider (e.g., surgeon, radiologist, clinician, analyst, physician) and/or a patient. For example, a cardiac surgeon may set up an image hanging protocol to view volume images of the heart from multiple angles. As another example, a clinician may set up an image hanging protocol to display the most recent volume images of an organ and/or functional system. As another example, an analyst of disease progression may set up an image hanging protocol to view and compare volume images of an organ and/or functional system from a current study and corresponding volume images of the organ and/or functional system from a historical study.

In certain embodiments of the present invention, the image hanging protocol may be created and/or selected by a system, such as the PACS system 100 of FIG. 1. For example, a user issues a command to display an exam, and the system automatically selects the hanging protocol, applies it (e.g., compares volume images from the current study and a historical study), and displays the images.

In certain embodiments of the present invention, the image hanging protocol may remove or eliminate voxels that are not associated with the organ or functional system of interest. The image hanging protocol may employ any number of methods to eliminate or remove voxels that are not associated with the organ or functional system of interest. For example, a look-up table may be employed to eliminate or remove voxels that are not associated with the organ or functional system of interest. Alternatively, or in conjunction, image processing tools, such as segmentation, classification, and pattern recognition, may be employed.

In certain embodiments of the present invention, the image hanging protocol may direct a display device to display body part components, such as an organ or functional system, in isolation. For example, a hanging protocol may employ filters that specify the organ or functional component to be displayed on a display device. The filter may remove or eliminate voxels that are not associated with the organ or functional system of interest. Any number of methods may be employed to eliminate or remove voxels that are not associated with the organ and/or functional system of interest. For example, a look-up table may be employed to eliminate or remove voxels that are not associated with the organ or functional system of interest. Alternatively, or in conjunction, image processing tools, such as segmentation, classification, and pattern recognition, may be employed. The removal or elimination of voxels that are not associated with the organ and/or functional system of interest allows for the separation of the volume image of the organ and/or functional system of interest from the volume image as a whole. Such separation allows the user to view different body part components in isolation.

At step 240, one or more volume images are displayed based at least in part on the selected imaging hanging protocol. The images may be displayed by the PACS system 100. More particularly, the images may be displayed by the display device 140 of the PACS system 100. The one or more images may include the volume image set acquired at step 210 and/or a volume image formed by voxels associated with an organ and/or functional system at step 230.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

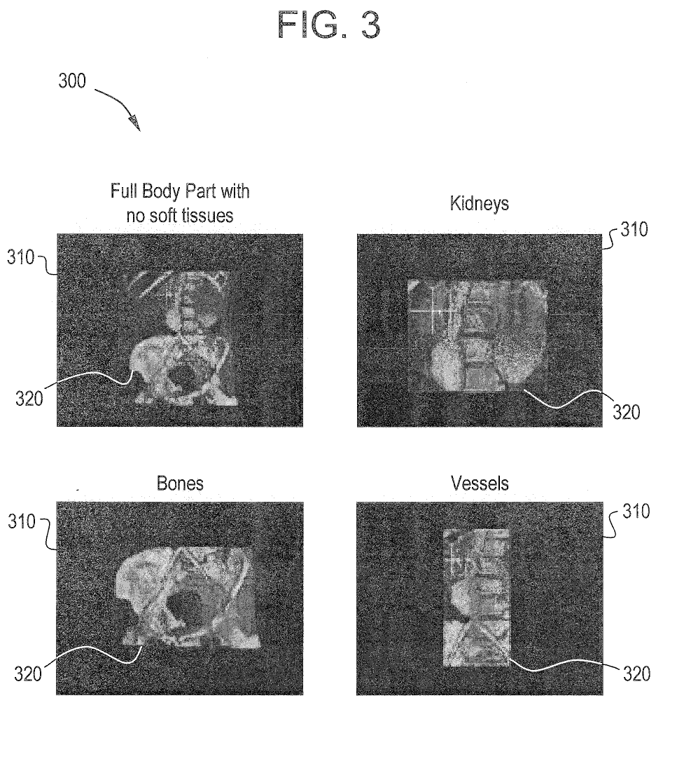

FIG. 3 illustrates an exemplary display 300, such as would be displayed on the display device 140 of the PACS system 100, according to an embodiment of the present invention. The display 300 includes four image regions 310, although any number of image regions 310 may be implemented. The image regions 310 may include one or more images 320. For example, the images shown in FIG. 3 are FULL BODY PART WITH NO SOFT TISSUES, KIDNEYS, BONES, and VESSELS.

In certain embodiments of the present invention, the one or more images may be matched on, loaded, and/or displayed based at least in part on an image hanging protocol. In certain embodiments, the one or more images may be automatically matched on, loaded, and/or displayed.

The image hanging protocol may include a rule set. The rule set may include one or more rules. For example, the rule set may include a rule for displaying an organ and/or functional system. As another example, the rule set may include a rule for eliminating or removing voxels that are not associated with the organ or functional system of interest. As another example, the rule set may include a rule for displaying an organ and/or functional system in isolation.

As an example, the following hanging protocol specification may be used to generate display 300:

```
<Monitors>
  <Monitor>
    <Row>
      <ImageView>
        <Component> BodyPart </Component>
        <Filter> NoSoftTissue</Filter>
      </ImageView>
      <ImageView>
        <Component> BodyPart </Component>
        <Filter> Kidney</Filter>
      </ImageView>
    </Row>
      <Row>
      <ImageView>
        <Component> BodyPart </Component>
        <Filter> Bones </Filter>
      </ImageView>
      <ImageView>
        <Component> BodyPart </Component>
        <Filter> Vessels </Filter>
      </ImageView>
    </Row>
  </Monitor>
</Monitors>
```

As discussed above, display 300 may be displayed on display device 140. The components, elements, and/or functionality of the display device 140 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

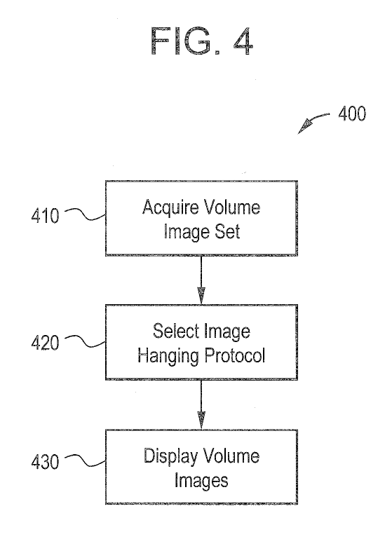

FIG. 4 illustrates an image display method 400 according to an embodiment of the present invention. The method 400 includes the following steps, which are described below in more detail. At step 410, a volume image set is acquired. At step 420, an image hanging protocol is selected. At step 430, a volume image set is displayed. The method 400 is described with reference to the elements of the display 300 described above, but it should be understood that other implementations are possible.

At step 410, a volume image set is acquired. The volume image set may be acquired by the PACS system 100. More particularly, the volume image set may be acquired by the imaging modality 110 of the PACS system 100. The volume image set may include one or more volume images. PACS system 100 may have applied one or more preprocessing functions to the image data. One or more preprocessing functions may be applied to the image data prior to acquisition of the volume image set. For example, a 3-dimensional processing function may have been applied to image data to generate a volume image. As another example, image data attributes may be attached to or associated with the image(s).

At step 420, an image hanging protocol is selected. As described above, a hanging protocol is a set of display rules for presenting, formatting, and otherwise organizing images on a display device. A display rule is a convention for presenting one or more images in particular temporal and/or spatial layout or sequence. For example, a hanging protocol may include a set of computer-readable instructions (or display rules, for example) that direct a computer to display a plurality of images in certain locations on a display device and/or display the plurality of images in a certain sequence or order. The set of display rules may include one or more rules.

In certain embodiments of the present invention, the image hanging protocol may be created and/or selected by a system, such as the PACS system 100 of FIG. 1. For example, a user issues a command to display an exam, and the system automatically selects the hanging protocol, applies it (e.g., compares volume images from the current study and a historical study), and displays the images.

In certain embodiments of the present invention, the rule set of the image hanging protocol may include a rule for displaying an organ and/or functional system in certain locations on a display device and/or display the plurality of images of an organ and/or functional system in a certain sequence or order. For example, the image region 310 in the lower left-hand corner of display 300 displays a volume image of bones. As another example, the image region 310 in the upper right-hand corner of display 300 displays a volume image of the kidneys.

In certain embodiments of the present invention, the image hanging protocol may remove or eliminate voxels that are not associated with the organ or functional system of interest. The image hanging protocol may employ any number of methods to eliminate or remove voxels that are not associated with the organ or functional system of interest. For example, a look-up table may be employed to eliminate or remove voxels that are not associated with the organ or functional system of interest. Alternatively, or in conjunction, image processing tools, such as segmentation, classification, and pattern recognition, may be employed.

In certain embodiments of the present invention, the image hanging protocol may direct a display device to display organs or functional systems in isolation. For example, a hanging protocol may employ filters that specify the organ or functional component to be displayed on a display device. The filter may remove or eliminate voxels that are not associated with the organ or functional system of interest. Any number of methods may be employed to eliminate or remove voxels that are not associated with the organ and/or functional system of interest. For example, a look-up table may be employed to eliminate or remove voxels that are not associated with the organ or functional system of interest. Alternatively, or in conjunction, image processing tools, such as segmentation, classification, and pattern recognition, may be employed.

At step 430, a volume image set is displayed. The volume images may be displayed based at least in part on the image hanging protocol selected at step 420. The volume images displayed may include the whole volume image acquired at step 410 or a portion thereof. For example, an isolated organ or functional system may be displayed at step 430.

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

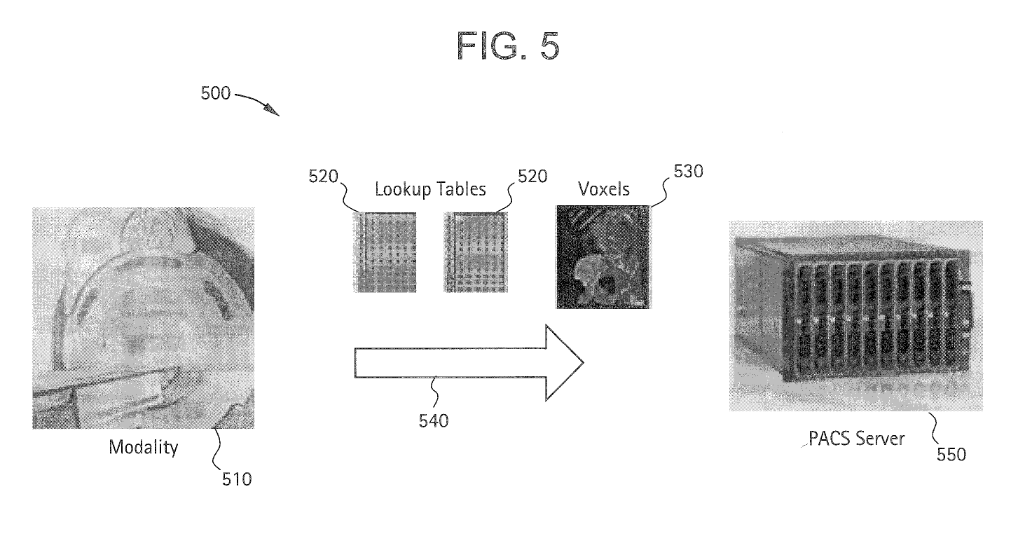

FIG. 5 illustrates an exemplary PACS system 500 according to an embodiment of the present invention. PACS system 500 includes an imaging modality 510, lookup tables 520, a volume image 530, a communication component 540, and a PACS server 550. While system 500 is illustrated in FIG. 5 as including a single imaging modality 510, two lookup tables 520, a single volume image 530, a single communication component 540, and a single PACS server 550, system 500 can include any number of imaging modalities 510, lookup tables 520, volume images 530, communication components 540, and PACS servers 550. In other words, no embodiment of the present invention is in any way limited to the illustration of system 500 as illustrated in FIG. 5.

Imaging modality 510 is capable of communicating with PACS server 550 via communication component 540. Communication between various components may occur over hardwired, wireless, or a combination of hardwired or wireless connections.

In operation, imaging modality 510 obtains one or more images of a patient anatomy. Imaging modality 510 can include any device capable of capturing an image of a patient anatomy, such as a medical diagnostic imaging device. Imaging modality 510 can include an x-ray imager, ultrasound scanner, magnetic resonance imager, computed radiography/tomography imager, nuclear imager, or the like. As shown in FIG. 5, imaging modality 510 may also include a whole body imager, such as a computed tomography imager or magnetic resonance imager. Image data representative of the image(s) (including associated lookup tables 520) are communicated between imaging modality 510 and PACS server 550 via communication component 540. The image data can be communicated electronically over a wired or wireless connection, for example.

The lookup tables 520 can be used to associate voxels of volume image 530 with an organ and/or functional system. The association of voxels of volume image 530 with an organ and/or functional system allows for the separation of an organ and/or functional system from the volume image as a whole. This separation of an organ and/or functional system from the volume image as a whole may be affected by an image hanging protocol. The image hanging protocol may employ the lookup tables 520 to eliminate or remove voxels from the volume image 530 that are not associated with the organ or functional system of interest.

As discussed above, the components, elements, and/or functionality of the PACS system 500 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

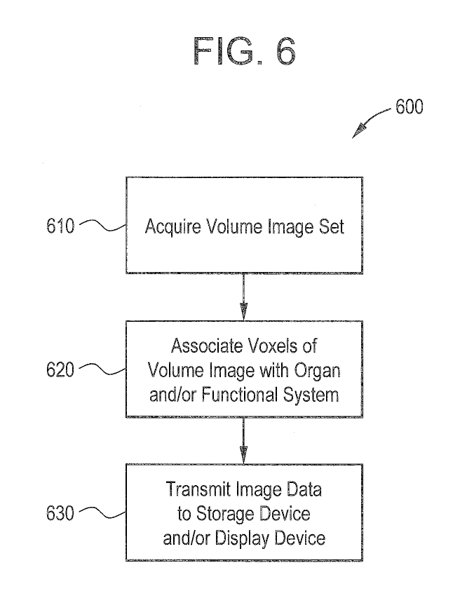

FIG. 6 illustrates an exemplary image processing method 600 according to an embodiment of the present invention. The method 600 includes the following steps, which are described below in more detail. At step 610, a volume image set is acquired. At step 620, each voxel of a volume image is associated with an organ or functional system. At step 630, the image data (and associated image data attribute(s)) are transmitted to a storage device and/or display device. The method 600 is described with reference to the elements of the PACS system 500 described above, but it should be understood that other implementations are possible.

At step 610, a volume image set is acquired. The volume image set may be acquired by the PACS system 500. More particularly, the volume image set may be acquired by the imaging modality 510 of the PACS system 500. The volume image set may include one or more volume images. The volume image set may include volume images reconstructed from 2-dimensional slice images. For example, a volume image may be constructed from RGB and alpha (opacity) values.

At step 620, the voxels of the volume images are associated with an organ and/or functional system. For example, image data attributes may be attached to or associated with the image(s). An image data attribute may include a label that associates or links a voxel with an organ and/or functional system. Any number of methods may be employed to link a voxel to an organ and/or functional system. For example, a look-up table may be employed to associate a voxel with an organ and/or functional system. Alternatively, or in conjunction, image processing tools, such as segmentation, classification, and pattern recognition, may be employed.

At step 630, the image data (and associated image data attribute(s)) are transmitted to a storage device and/or display device. A storage device may include any computer-readable storage and retrieval device that is accessible over an intranet or over the Internet. The image data (and associated image data attribute(s)) may be communicated electronically over a wired or wireless connection.

One or more of the steps of the method 600 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

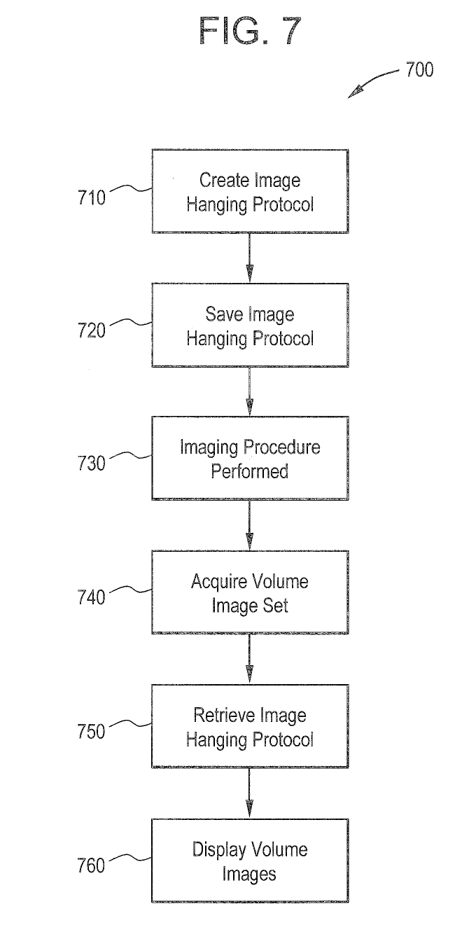

FIG. 7 illustrates an exemplary clinical review workflow 700 according to an embodiment of the present invention. The workflow 700 includes the following steps, which are described below in more detail. At step 710, a clinician creates an imaging hanging protocol to display volume images. At step 720, the image hanging protocol is saved. At step 730, an imaging procedure is performed. At step 740, a volume image set is acquired. At step 750, the image hanging protocol is retrieved. At step 760, the volume images are displayed. The workflow 700 is described with reference to the elements of the PACS system 100 and the steps of the image display method 200, but it should be understood that other implementations are possible.

At step 710, a clinician creates an imaging hanging protocol to display volume images. At step 720, the image hanging protocol is saved. Alternatively, the clinician may select a predefined image hanging protocol. The image hanging protocol may be created, selected, and/or saved using the PACS system 100. The image hanging protocol may be the image hanging protocol selected at step 230 of the method 200.

At step 730, an imaging procedure is performed. For example, a patient may undergo an imaging procedure. An imaging procedure may include using a medical diagnostic imaging device to capture images of patient body parts or the whole body of the patient. An imaging procedure may include the taking of one or more images of a certain patient anatomy. For example, an imaging procedure may identify which patient anatomy (such as a patient's head, neck or chest) is featured or shown in one or more images, for example. An imaging procedure may also include the particular imaging modality used to obtain one or more images and/or particular type or class of imaging modality used to obtain one or more images. A particular imaging modality may be a particular imaging modality device or a plurality of imaging modality devices. In another example, a particular type or class of imaging modality may be a C-arm x-ray imaging device, magnetic resonance (“MR”) imaging device, etc.

At step 740, a volume image set is acquired. The volume image set may the volume image set acquired at step 210 of the image display method 200. One or more processing functions may be applied to the image data prior to acquisition of the volume image set. For example, a 3-dimensional processing function may have been applied to image data to generate a volume image.

At step 750, the image hanging protocol is retrieved. At step 760, the volume images are displayed. The volume images may be displayed based at least in part on the image hanging protocol created at step 710.

Steps 740-760 of the workflow 700 may be performed using the PACS system 100. In certain embodiments of the present invention, steps 740-760 of the workflow 700 may be automated. For example, the volume images may be displayed automatically at step 760.

One or more of the steps of the surgical review workflow 700 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any image sharing system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A method for displaying a volume image set, said method including:
selecting an image hanging protocol, wherein said image hanging protocol includes a rule set for displaying one or more volume images based at least in part on a body part component; and
displaying said one or more volume images based at least in part on said image hanging protocol.

2. The method of claim 1, wherein said body part component includes a functional system.

3. The method of claim 1, wherein said body part component includes an organ.

4. The method of claim 1, further including the step of associating a volume element of said one or more volume images with said body part component.

5. The method of claim 1, further including the step of separating at least one of said one or more volume images based at least in part on said body part component.

6. The method of claim 5, wherein said one or more volume images includes a volume image of one or more isolated organs.

7. The method of claim 1, wherein said rule set includes a rule for automatically displaying said one or more volume images based at least in part on said body part component.

8. The method of claim 7, wherein said displaying step includes automatically displaying said one or more volume images based at least in part on said image hanging protocol.

9. The method of claim 1, further including the step of acquiring said volume image set.

10. A system for displaying a volume image set, said system including:
a display device adapted to display one or more volume images based at least in part on an image hanging protocol, wherein said image hanging protocol includes a rule set for displaying said one or more volume images based at least in part on a body part component.

11. The system of claim 10, wherein said body part component includes at least one of an organ and a functional system.

12. The system of claim 10, further including an imaging modality adapted to acquire said volume image set.

13. The system of claim 10, further including a network server adapted to store said volume image set.

14. The system of claim 10, further including an acquisition workstation adapted to associate a volume element of said one or more volume images with said body part component.

15. The system of claim 14, further including a network server adapted to store said association between said volume element and said body part component.

16. The system of claim 14, wherein said acquisition workstation is adapted to separate at least one of said one or more volume images based at least in part on said association between said volume element and said body part component.

17. The system of claim 10, further including an acquisition workstation adapted to separate at least one of said one or more volume images based at least in part on said body part component.

18. The system of claim 10, wherein said one or more volume images includes a volume image of at least one isolated organ.

19. The system of claim 10, wherein the system is a picture archiving and communication system.

20. A computer-readable storage medium including a set of instructions for execution on a computer, the set of instructions including:
a selection routine configured to select an image hanging protocol, wherein said image hanging protocol includes a rule set for displaying a volume image set based at least in part on a body part component; and
a display routine configured to display said volume image set based at least in part on said image hanging protocol.

21. An image hanging protocol including a rule set for displaying a volume image set based at least in part on a body part component.
